(19) United States
(12) Patent Application Publication
(10) Pub. No.: US 2019/0088186 A1
(43) Pub. Date: Mar. 21, 2019

(54) DISPLAY DEVICE

(71) Applicant: Innolux Corporation, Miao-Li County (TW)

(72) Inventors: Hsin-Yi HUANG, Miao-Li County (TW); Chun-Hsu LIN, Miao-Li County (TW); Ming-Feng HSIEH, Miao-Li County (TW)

(21) Appl. No.: 16/102,996

(22) Filed: Aug. 14, 2018

(30) Foreign Application Priority Data
Sep. 19, 2017 (CN) 201710847709.9

(51) Int. Cl. G09G 3/20; F21V 8/00; G09G 3/22; G02B 6/24

(52) U.S. Cl. CPC G09G 3/2003; G02B 6/243; G09G 3/22; G02B 6/0026

(57) ABSTRACT

A display device is provided. The display device includes a display panel and a backlight module, the backlight module is corresponding disposed to the display panel. The backlight module emits a backlight having a backlight spectrum. The backlight spectrum includes a first waveband and a second waveband. The first waveband is within a range of 380 nm to 480 nm, and has a first integrated light intensity I(B). The second waveband is within a range of 481 nm to 600 nm, and has a sub-waveband within a range of 550 nm to 600 nm. The sub-waveband has a integrated light intensity I(G′), and a ratio of the integrated light intensity to the first integrated light intensity (I(G′)/I(B)) is within a range of 5% to 35%.

This application claims the benefit of People's Republic of China application Serial No. 201710847709.9, filed Sep. 19, 2017, the subject matter of which is incorporated herein by reference.

### BACKGROUND OF THE INVENTION

### Field of the Invention

The invention relates in general to a display device, and more particularly to a display device having a wide color gamut backlight module.

### Description of the Related Art

In recent years, the wide color gamut display has become an essential part in the display technology. To achieve the wide color gamut display, the display must meet several requirements such as high color saturation, high contrast or high color resolution. High color saturation can be achieved through the use of a modified light-resist or a modified backlight module. In comparison to the modified backlight module, the modification of the photo-resist has a higher development cost, or has more restrictions in terms of material compatibility or process design. On the other hand, the development of the backlight module is more flexible, or the material selection is more diversified, so that has become a focus of competition to the display manufacturers.

The light emitting material of the wide color gamut backlight module commonly seen in the market can have a ratio specification of the NTSC more than 100%, but that is still far behind the Rec.2020 specification of the International Telecommunication Union (ITU), Although we can achieve a higher standard than the Rec.2020 specification by the quantum dot light-conversion material film containing cadmium (Cd), but the Cd containing material is environmental unfriendly or incurs higher cost. Therefore, how to provide a wide color gamut backlight module which is environmental friendly or meets the requirements of wide color gamut backlight module has become a prominent task for the industries.

### SUMMARY OF THE INVENTION

The invention is directed to a display device having a wide color gamut backlight module. According to the embodiments of the present disclosure, the backlight emitted by the backlight module of the display device has a backlight spectrum. In the backlight spectrum, the ratio of the integrated light intensity of the waveband within a range of 550 nm to 600 nm to the integrated light intensity of the waveband within a range of 380 nm to 480 nm is within a range of 5% to 35%, By adopting the backlight spectrum with the ratio design of the integrated light intensity of the waveband as disclosed above, the full width at half maximum of the spectrum generated by the backlight light source can be reduced, the coverage of color gamut can be increased, or the effect of wide color gamut can be achieved.

According to one embodiment of the present invention, a display device is provided. The display device includes a display panel and a backlight module corresponding to the display panel. The backlight module emits a backlight having a backlight spectrum. The backlight spectrum includes a first waveband and a second waveband. The first waveband is within a range of 380 nm to 480 nm and has a first integrated light intensity I(B), The second waveband is within a range of 481 nm to 600 nm and has a sub-waveband within a range of 550 nm to 600 nm, The sub-waveband has a integrated light intensity I(G′), and the ratio of the integrated light intensity to the first integrated light intensity (I(G′)/I(B)) is within a range of 5% to 35%.

According to another embodiment of the present invention, a display device is provided. The display device includes a display panel and a backlight module disposed corresponding to the display panel. The backlight module includes a backlight source and a light-conversion element disposed adjacent to the backlight source. The light-conversion element includes an organic fluorescent material having an absorption wavelength within a range of 550 nm to 600 nm, and the organic fluorescent material having an emission wavelength within a range of 640 nm to 650 nm. The backlight source emits a light having a first spectrum, the first spectrum is obtained before the light enters the light-conversion element, and a second spectrum is obtained after the light passes through the light-conversion element. The integrated light intensity of the second spectrum within the waveband of 550 nm to 600 nm is less than the integrated light intensity of the first spectrum within the waveband of 550 nm to 600 nm, and the integrated light intensity of the second spectrum within the waveband of 640 nm to 650 nm is greater than the integrated light intensity of the first spectrum within the waveband of 640 nm to 650 nm.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a spectrum diagram of a backlight emitted by a backlight module of a display device according to an embodiment of the present disclosure.

FIG. 2 is a schematic diagram of a display device according to an embodiment of the present disclosure.

FIG. 3 is a diagram of an emission spectrum according to an embodiment of the present disclosure.

FIG. 4 to FIG.5 are schematic diagrams of a display device according to some embodiments of the present disclosure.

FIG. 6 to FIG.11 are configuration diagrams of a backlight source and a light-conversion element according to some embodiments of the present disclosure.

FIG. 12 to FIG. 14 are schematic diagrams of a display device according to some other embodiments of the present disclosure.

FIG. 15 is a schematic diagram of a backlight module according to an embodiment of the present disclosure.

### DETAILED DESCRIPTION OF THE INVENTION

According to the embodiments of the present disclosure, the backlight emitted by the backlight module of the display device has a backlight spectrum. In the backlight spectrum, the ratio of the integrated light intensity of the waveband within a range of 550 nm to 600 nm to the integrated light intensity of the waveband within a range of 380 nm to 480 nm is within a range of 5% to 35%. By adopting the backlight spectrum with the ratio design of the integrated light intensity of the waveband as disclosed above, the full width at half maximum of the spectrum generated by the backlight light source can be reduced, the coverage of color gamut can be increased, or the effect of wide color gamut can be achieved.

A number of embodiments of the present disclosure are disclosed below with reference to accompanying drawings. However, the structure and content disclosed in the embodiments are for exemplary and explanatory purposes only, and the scope of protection of the present disclosure is not limited to the embodiments. Designations common to the accompanying drawings and embodiments are used to indicate identical or similar elements. Anyone skilled in the technology field of the invention will be able to make suitable modifications or changes based on the specification disclosed below to meet actual needs without breaching the spirit of the invention. Besides, a certain layer is disposed “on” a second layer or a substrate may refer to the situation when the certain layer is “directly” or “indirectly” disposed on the second layer or the substrate. There can exist another layer disposed between the certain layer and the second layer or the substrate. That a certain layer “contacts” a second layer or a substrate may refer to the situation when the certain layer “directly contacts” or “indirectly contacts” the second layer or the substrate. That is, there can be another layer disposed between the certain layer and the second layer or the substrate. Moreover, ordinal numbers, such as “the first”, “the second”, and “the third”, are used in the specification and claims to modify the components of the claims. The ordinal numbers of claim components do not imply or represent that the said components have any previous ordinal numbers, nor represent the sequence between a particular claimed component and another claimed component or the sequence of process in a manufacturing method. The ordinal numbers used to clearly distinguish the claimed components having the same designations.

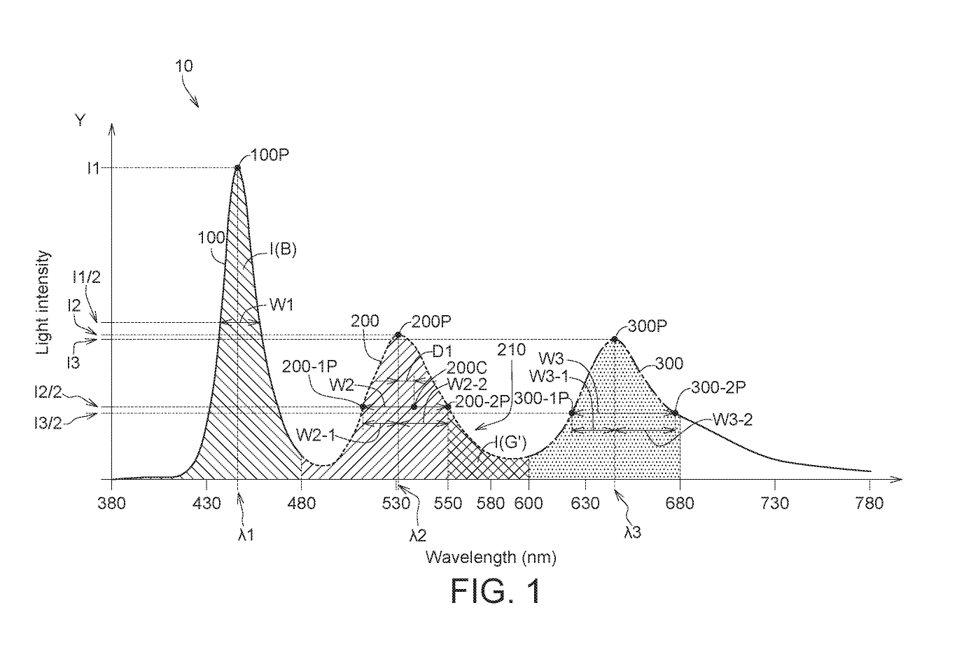

FIG. 1 is a spectrum diagram of a backlight emitted by a backlight module of a display device according to an embodiment of the present disclosure. The display device includes a display panel and a backlight module corresponding to the display panel. The backlight module emits a backlight having a backlight spectrum 10. The display panel includes Liquid crystal (LC), organic light-emitting diode (OLED), quantum dot (QD), fluorescent material, phosphor material, light-emitting diode (LED), micro light-emitting diode or mini light-emitting diode or other display medium, but the disclosure is not limited thereto. In some embodiments, the size of the light emitting diode is about 300 micrometers (μm) to 10 millimeters (mm), and the size of the micro LED is about 100 micrometers (μm) to 300 micrometers (μm). The micro LED has a wafer size of about 1 micrometer (μm) to 100 micrometers (μm), but the disclosure is not limited thereto.

The backlight spectrum 10 includes a first waveband 100 and a second waveband 200. The first waveband 100 is within a range of 380 nm to 480 nm and has a first integrated light intensity I(B). The second waveband 200 is within a range of 481 nm to 600 nm, and the second waveband 200 has a sub-waveband 210 within a range of 550 nm to 600 nm. The sub-waveband 210 of the second waveband 200 has an integrated light intensity I(G′), and the ratio of the integrated light intensity I(G′) to the first integrated light intensity I(B) may be within a range of 5% to 35%((I(G′)/I(B))=5% to 35%).

According to the embodiments of the present disclosure, the first waveband 100 may be a blue light waveband, the second waveband 200 may be a green light waveband, and the sub-waveband 210 of the second waveband 200 may be a yellow-green light waveband. According to the design of the backlight spectrum 10 of the embodiments of the present disclosure, the ratio of the integrated light intensity of the yellow-green light waveband to the integrated light intensity of the blue light waveband is within a range of 5% to 35%, the coverage of color gamut can be increased, or wide color gamut effect can be increased. A coverage ratio of the Rec.2020 specification of the backlight spectrum 10 can cover more than 85% or even more than 90% of the coverage ratio of the Rec.2020 specification.

Since human eyes may be sensitive to the yellow-green light within a range of 550 nm to 600 nm (the sub-waveband 210), human eyes may experience color deviation when the light intensity of the sub-waveband 210 is very small (or zero). For example, when the yellow color disappears, because the blue color is the contrast color of yellow color,a region originally may be sensed as red, but the region actually be sensed like purple. According to the embodiments of the present disclosure, when the ratio of the integrated light intensity I(G′) (the yellow-green light) to the first integrated light intensity I(B) (the blue light) is at least equivalent to or greater than 5% (5%≤I(G′)/(B)), the color deviation can be reduced, or the problem of inferior color taste of the vision can be reduced.

In some embodiments, the ratio of the integrated light intensity I(G′) to the first integrated light intensity I(B) can be within a range of 5% to 17% (5%≤I(G′)/I(B)≤17%), such that the coverage of the Rec.2020 specification or the color saturation can be increased.

In some embodiments, the ratio of the integrated light intensity I(G′) to the first integrated light intensity I(B) can be within a range of 18% to 35% (18% I(G′)/I(B) 35%), such that the brightness of the backlight can be increased or the color saturation can be increased.

As indicated in FIG. 1, the first waveband 100 has a crest 100P corresponding to a first wavelength λ1 within a range of 445 nm to 455 nm. In an embodiment, the first wavelength λ1 can be 450 nm.

In an embodiment, the first waveband 100 has a full width at half maximum W1 within a range of 16 nm to 22 nm (16 nm≤W1≤22 nm).

As indicated in FIG. 1, the second waveband 200 has a crest 200P corresponding to a second wavelength λ2 within a range of 515 nm to 545 nm (515 nm≤λ2 545 nm). In some embodiments, the second wavelength λ2 can be within a range of 520 nm to 540 nm (520 nm≤λ2≤540 nm).

In an embodiment, the difference between the first wavelength λ1 of the crest 100P and the second wavelength λ2 of the crest 200P is within a range of 66 nm to 97 nm (that is, 66 nm≤λ2−λ1≤97 nm).

In some embodiments as indicated in FIG. 1, the curve of light intensity within the second waveband 200 can have an asymmetrical shape. The second waveband 200 has a crest 200P corresponding to a second wavelength λ2 within a range of 515 nm to 545 nm (515 nm≤λ2 545 nm), and the second waveband 200 has a second waveband central point 2000 corresponding to a wavelength is separated from the second wavelength λ2 by a difference D1 within a range of 3 nm to 8 nm (3 nm≤D1≤8 nm), wherein the second wavelength λ2 may be less than the wavelength of the second waveband central point 200C, and the second wavelength λ2 is shifted to the direction of shorter wavelengths with respect to the second waveband central point 2000. In an embodiment, the second waveband central point 2000 may be the middle value of the wavelength range of the second waveband 200. Since the second waveband 200 is within a range of 481 nm to 600 nm, the second waveband central point 2000 corresponding to a wavelength of 540 nm.

In an embodiment, the second waveband 200 has a full width at half maximum W2, the full width at half maximum is defined as the distance between a point 200-1P and a point 200-2P, the point 200-1P and the point 200-2P may be defined by the intersections of a straight line Y=I2/2 and the curve of light intensity within the second waveband 200 of the backlight spectrum, wherein the Y-axis denotes the light intensity, I2/2 denotes a half of the second crest intensity I2 of the crest 200P, the point 200-1P is the intersection at the side with shorter wavelengths, and the point 200-2P is the intersection at the side with longer wavelengths. The full width at half maximum W2 of the second waveband 200 is within a range of 36 nm to 49 nm (36 nm≤W2≤49 nm). According to the embodiments of the present disclosure, the second waveband 200 can be a green light waveband. When the full width at half maximum W2 of the green light waveband is designed to be within a range of 36 to 49 nm, the light intensity of the overlapping region between the green waveband and the red waveband can be reduced, the green color saturation and the red color saturation can be increased, or the coverage of color gamut can be increased.

Since the crest 200P is shifted to the direction of shorter wavelengths, the curve of light intensity within the second waveband 200 has an asymmetrical shape. For example, the crest 200P is used as a segmentation point, the full width at half maximum W2 of the second waveband 200 can be divided into a full width of the full width at half maximum with shorter wavelengths W2-1 and a full width of the full width at half maximum with longer wavelengths W2-2. The full width of the full width at half maximum with shorter wavelengths W2-1 is less than the full width of the full width at half maximum with longer wavelengths W2-2. In some embodiments, the absolute value of the difference between the full width of the full width at half maximum with shorter wavelengths W2-1 and the full width of the full width at half maximum with longer wavelengths W2-2 is within a range of 3 nm to 4 nm (3 nm≤|W2-2-W2-1|≤4 nm). In some embodiments, the absolute value of the difference between the full width of the full width at half maximum with shorter wavelengths W2-1 and the full width of the full width at half maximum with longer wavelengths W2-2 is within a range of 7 nm to 8 nm (7 nm≤|W2-2-W2-1|≤8 nm).

In an embodiment, the crest 100P of the first waveband 100 has a first crest intensity I1, the crest 200P of the second waveband 200 has a second crest intensity I2, and the ratio of the second crest intensity I2 to the first crest intensity I1 may be within a range of 25% to 70% (25%≤I2/I1≤70%).

As indicated in FIG. 1, the backlight spectrum 10 of the display device 1 may further include a third waveband 300 within a range of 601 nm to 780 nm. The third waveband 300 has a crest 300P corresponding to a third wavelength λ3 within a range of 630 nm to 660 nm (630 nm≤λ3≤660 nm). In some embodiments, the third wavelength λ3 may be within a range of 635 nm to 650 nm (635 nm≤λ3≤650 nm). In some other embodiments, the third wavelength λ3 may be within a range of 642 nm to 645 nm (642 nm ≤λ3≤645 nm).

In an embodiment, the difference between the third wavelength λ3 of the crest 300P and the first wavelength λ1 of the crest 100P may be within a range of 194 nm to 204 nm (194 nm≤λ3-λ1≤204 nm). In an embodiment, the difference between the third wavelength λ3 of the crest 300P and the second wavelength λ2 of the crest 200P may be within a range of 102 nm to 123 nm (102 nm≤λ3-λ2≤123 nm).

In an embodiment, the third waveband 300 has a full width at half maximum W3, the full width at half maximum VV is defined as the distance between a point 300-1P and a point 300-2P, the point 300-1P and the point 300-2P are defined by the intersections of a straight line Y=I3/2 and the curve of light intensity within the third waveband 300 of the backlight spectrum, wherein the Y-axis denotes the light intensity, I3/2 denotes a half of the third crest intensity I3 of the crest 300P, the point 300-1P is the intersection at the side with shorter wavelengths of the third waveband 300, and the point 300-2P is the intersection at the side with longer wavelengths of the third waveband 300. The full width at half maximum W3 of the third waveband 300 is within a range of 30 nm to 60 nm (30 nm≤W3≤60 nm).

Since the crest 300P of the third waveband 300 is shifted to the direction of shorter wavelengths, the curve of light intensity within the third waveband 300 has asymmetrical shape. For example, the crest 300P is used as a segmentation point, the full width at half maximum W3 of the third waveband 300 can be divided into a full width of the full width at half maximum with shorter wavelengths W3-1 and a full width of the full width at half maximum with longer wavelengths W3-2. The full width of the full width at half maximum with shorter wavelengths W3-1 is less than the full width of the full width at half maximum with longer wavelengths W3-2. In some embodiments, the absolute value of the difference between the full width of the full width at half maximum with shorter wavelengths W3-1 and the full width of the full width at half maximum with longer wavelengths W3-2 is within a range of 3 nm to 4 nm (3 nm≤|W3-2-W3-1|≤4 nm).

In an embodiment, the crest 300P of the third waveband 300 has a third crest intensity I3, and the ratio of the third crest intensity I3 to the first crest intensity I1 is within a range of 30% to 70% (30%≤I3/I1≤70%).

In an embodiment, the ratio of the third crest intensity I3 to the second crest intensity I2 is within a range of 89% to 140% (89%≤I3/I2≤140%).

The backlight spectrum 10 according to the embodiments of the present disclosure can be implemented by different ways. For example, the backlight spectrum 10 can be implemented by light emitting diodes having two or three predetermined emission wavelengths (such as the blue, the green, or the red colors). In some other embodiments, the backlight spectrum 10 can be implemented by a light emitting material (or light-conversion material) having two or three of the predetermined emission wavelengths as mentioned above and at least one light emitting diode (such as a blue light emitting diode, a yellow light emitting diode or an UV light emitting diode). In some yet other embodiments, the backlight spectrum 10 can be implemented by multiple light-conversion materials capable of absorbing the light within a specific range of wavelengths and emitting the light within a specific range of wavelengths and at least one light emitting diode (such as a blue light emitting diode, a yellow light emitting diode or a UV light emitting diode). Through suitable combination of the above methods, the backlight module can emit a backlight having the backlight spectrum, but it should be note that the application of the present disclosure is not limited to be implemented by the above methods. The backlight spectrum 10 can be measured using a spectroradiometer CS-2000 or other instruments suitable for measuring the spectrum. For example, after the backlight module is turned on and pre-heated for 10 to 15 minutes to make the backlight source become stable, the backlight module may be divided into 9 equal grids arranged as a 3×3 matrix. Each grid may be measured for 3 times, and an average of the 3 measurements of each grid is obtained. Then, the backlight spectrum may obtained by averaging the measurements of the 9 grids. However, the disclosure is not limited to such a measurement method. The backlight module can be implemented with different designs, and the measurement can be performed by using the backlight module in combination with a light guide plate, a brightness enhancement film (BEF), a dual brightness enhancement film (DBEF), an XBEF, a DDF, or other optical film that is not affecting the spectrum, or any combination thereof. For example, the DDF is a low haze diffuser making the BLU brightness uniformly distributed. The brightness enhancement film (BEF) is a prism sheet capable of changing the optical path according to the Snell's Law and deflecting the light to the front viewing direction, such that the light can be collected and the brightness can be enhanced. The measurement method exemplified above can have different combinations, and the present disclosure is not limited thereto.

The present disclosure is further described using some embodiments below. It should be noted that detailed structures disclosed in the embodiments are for exemplification purpose only, not for limiting the scope of protection of the present disclosure.

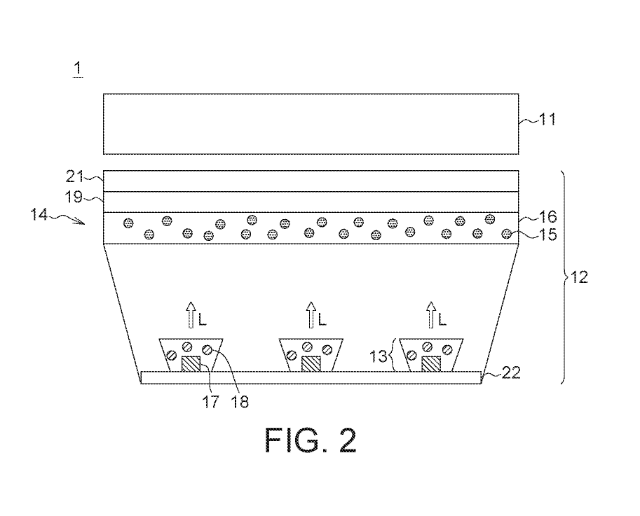

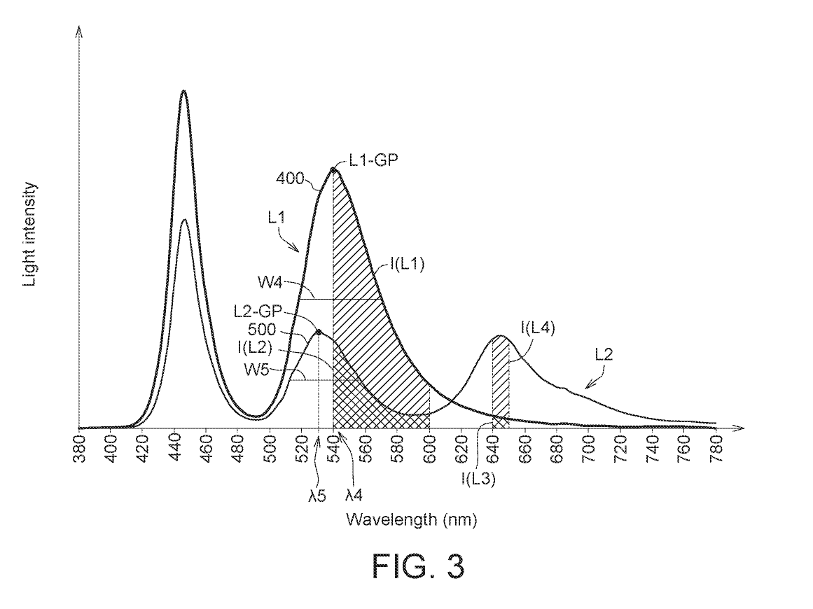

FIG. 2 is a schematic diagram of a display device according to an embodiment of the present disclosure. FIG. 3 is a diagram of an emission spectrum according to an embodiment of the present disclosure. For elements of the present embodiment similar or identical to that of above embodiments, similar or identical designations are used. Relevant descriptions of similar or identical elements which can be obtained with reference to above disclosure are not redundantly repeated here.

The display device 1 includes a display panel 11 and a backlight module 12, the backlight module 12 disposed corresponding to the display panel 11. The backlight module 12 includes at least a backlight source 13 and a light-conversion element 14 disposed adjacent to the backlight source 13.

The light-conversion element 14 includes organic fluorescent material 15 having an absorption wavelength within a range of 550 to 600 nm and an emission wavelength within a range of 640 to 650 nm. The backlight source 13 emits a light L having a first spectrum L1 obtained before the light L enters the light-conversion element 14, and a second spectrum L2 obtained after the light

L passes through the light-conversion element 14. As indicated in FIG. 3, the integrated light intensity I(L2) of the second spectrum L2 within a range of 550 to 600 nm is less than the integrated light intensity I(L1) of the first spectrum L1 within the range of 550 to 600 nm; or the integrated light intensity I(L4) of the second spectrum L2 within a range of 640 to 650 nm is greater than the integrated light intensity I(L3) of the first spectrum L1 within the range of 640 to 650 nm.

The light-conversion element 14 can be disposed adjacent to the backlight source 13. For example, the light-conversion element 14 can be disposed above, besides or under the backlight source 13, the light-conversion element 14 can cover the backlight source 13. The light-conversion element 14 can be disposed on any combination of the above positions, or can be even packaged on at least a part of the top surface of the backlight source 13, and the present disclosure is not limited thereto. The light-conversion element 14 also can be implemented by mixing the organic fluorescent material 15 to any optical film (such as reflector, light guide plate, BEF, DEBF, diffuser or a prism sheet), other suitable film or any combination thereof, and the present disclosure is not limited thereto.

As indicated in FIG. 2, the backlight module 12 includes at least a backlight source 13 and a light-conversion element 14 disposed adjacent to the backlight source 13. In the example of FIG. 2, the wavelength conversion element 14 can be a film structure disposed on the backlight source 13, and the wavelength conversion element 14 can include an organic fluorescent material 15 having an absorption wavelength within a range of 550 nm to 600 nm, and the organic fluorescent material 15 having an emission wavelength within a range of 640 nm to 650 nm.

In an embodiment as indicated in FIG. 3, before the light L enters the light-conversion element 14, the first spectrum L1 of the light L has a fourth waveband 400 within a range of 481 nm to 600 nm. The crest L1-GP of the fourth waveband 400 has a fourth wavelength λ4 within a range of 539 nm to 543 nm (539 nm =λ4 543 nm), such as 541 nm. The fourth waveband 400 has a full width at half maximum W4 within a range of 50 nm to 54 nm (50 nm W4≤54 nm), such as 52 nm. After the light L passes through the conversion element 14, the second spectrum L2 of the light L has a fifth waveband 500 within a range of 481 nm to 600 nm. The crest L2-GP of the fifth waveband 500 has a fifth wavelength λ5 within a range of 528 nm to 532 nm (528 nm≤λ5≤532 nm), such as 530 nm. The fifth waveband 500 has a full width at half maximum W5 within a range of 43 nm to 47 nm (43 nm≤W5≤47 nm), such as 45 nm. After the light L passing through the light-conversion element 14, the crest of the waveband within a range of 481 nm to 600 nm is shifted to the direction of shorter wavelengths for about 11 nm, and the full width at half maximum can be reduced by about 7 nm. For example, the difference between the full width at half maximum W5 and the full width at half maximum W4 is within a range of 7 nm to 11 nm (7 nm≤W4-W5≤11 nm).

In some embodiments, the first spectrum L1 can be implemented by a light source spectrum generated by a blue light emitting diode chip in conjunction with a green light emitting diode chip. In some other embodiments, the first spectrum L1 can be generated by the combination of a blue light emitting diode chip and a green light emitting material. The first spectrum L1 can be generated by exciting a green fluorescent body (such as a DENKA G200) using a blue light emitting diode chip) or can be generated by the combination of a blue light emitting diode chip and a green quantum dot material, but the disclosure is not limited. The second spectrum L2 can be obtained after the light source emitting the first spectrum L1 and passing through the light-conversion element 14. Both the first spectrum L1 and the second spectrum L2 can be measured by a spectroradiometer CS-2000 or other instrument suitable for measuring the spectrum.

In some embodiments as indicated in FIG. 2, the light-conversion element 14 includes a resin layer 16, the organic fluorescent material 15 can be mixed into the resin layer 16.

For example, as indicated in FIG. 2, the backlight source 13, such as a light emitting diode, includes a blue light emitting diode chip 17 and a green light emitting material 18. The green light emitting material 18 can be a green fluorescent body, a green quantum dot material or a combination thereof, and the present disclosure is not limited thereto. The green light emitting material 18 can be located in the package layer of the backlight source 13.

In an embodiment, the backlight module 12 of the display device 1 may further include at least an optical film disposed on the light-conversion element 14. The optical film, for example, can be a diffuser, a prism sheet or a brightness enhancement film. For example, as indicated in FIG. 2, the backlight module 12 of the display device 1 may further include a prism sheet 19 or a brightness enhancement film 21. In the example of FIG. 2, the optical film is disposed on the light-conversion element 14. In some other embodiments, the conversion element 14 can be alternatively disposed under the optical film. The position of the optical film and the position of the conversion element 14 can be replaced, and the present disclosure is not limited thereto.

In an embodiment as indicated in FIG. 2, the backlight module 12 of the display device 1 may further include a substrate 22, such as a rigid circuit board or a flexible circuit board. At least a backlight source 13 is disposed on the substrate 22. For example, the backlight source 13 is electrically soldered (connected) on the substrate 22, and the present disclosure is not limited thereto.

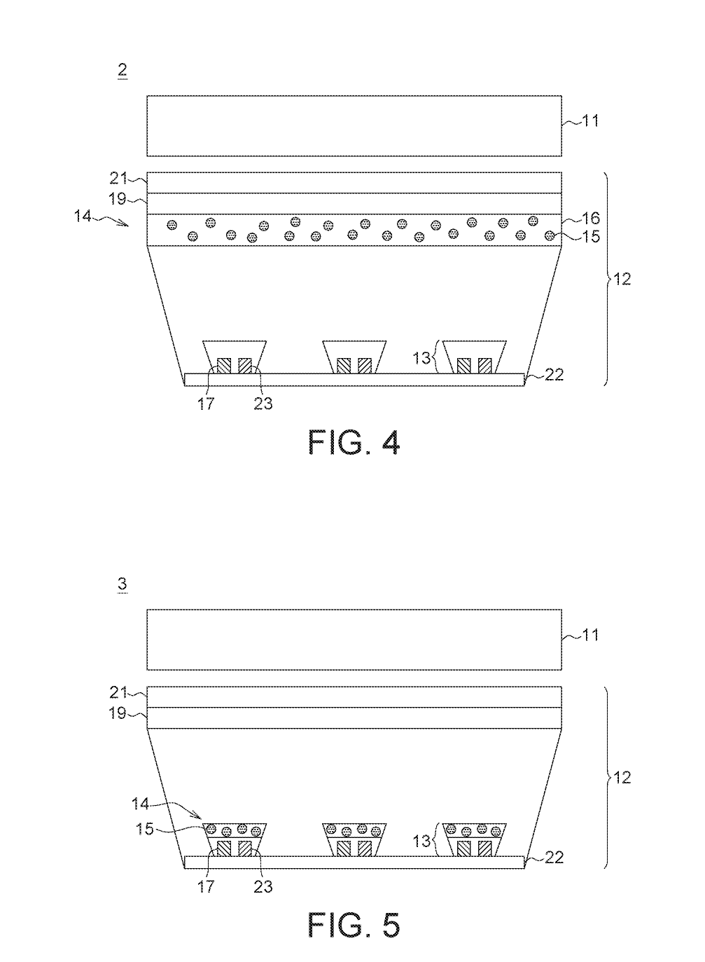

FIG. 4 to FIG. 5 are schematic diagrams of a display device according to some embodiments of the present disclosure. For elements of the present embodiment similar or identical to that of above embodiments, similar or identical designations are used. Relevant descriptions of similar or identical elements which can be obtained with reference to above disclosure are not redundantly repeated here.

In an embodiment as indicated in FIG. 4, in the backlight module 12 of the display device 2, the backlight source 13, such as a light emitting diode, includes a blue light emitting diode chip 17 and a green light emitting diode chip 23. The light-conversion element 14 is disposed adjacent to the backlight source 13, and the light-conversion element 14 includes a resin layer 16 and an organic fluorescent material 15 is mixed into the resin layer 16.

In some embodiments as indicated in FIG. 5, in the backlight module 12 of the display device 3, the backlight source 13 includes a blue light emitting diode chip 17, a green light emitting diode chip 23, and a light-conversion element 14 may be packaged on the top layer of a light emitting diode. The light-conversion element 14 includes a resin layer 16 and an organic fluorescent material 15 mixed into the resin layer 16. The backlight source 13 can emit a white light source. The optical film (such as the prism sheet 19 and the brightness enhancement film 21) is disposed on the light emitting diode, and the present disclosure is not limited thereto.

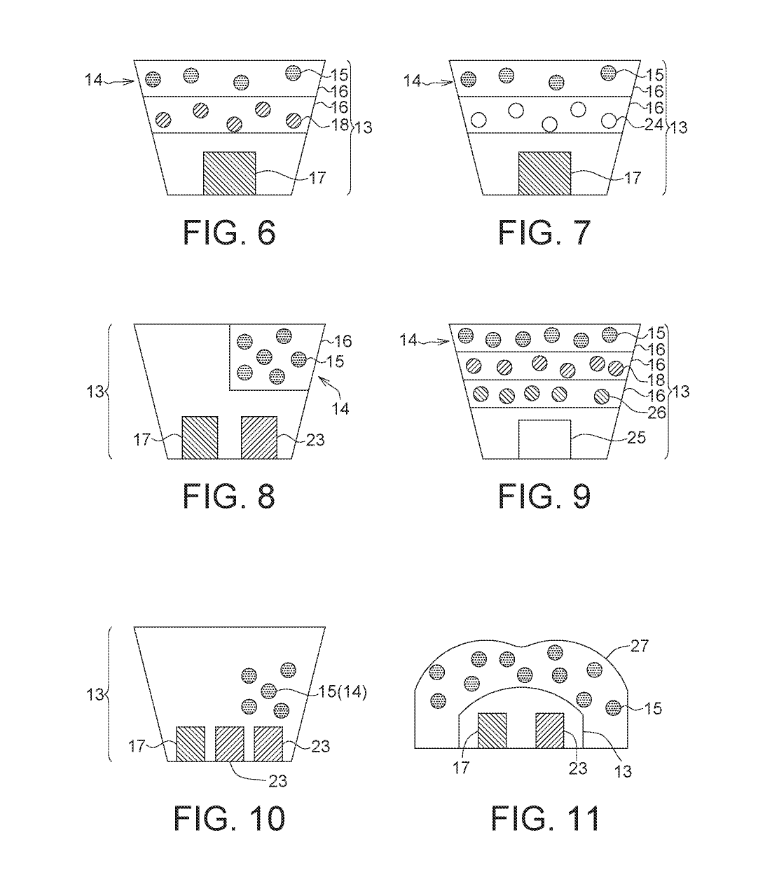

FIG. 6 to FIG. 11 are configuration diagrams of a backlight source and a light-conversion element according to some embodiments of the present disclosure. For elements of the present embodiment similar or identical to that of above embodiments, similar or identical designations are used. Relevant descriptions of similar or identical elements which can be obtained with reference to above disclosure are not repeated here.

In some embodiments as indicated in FIG. 6, the backlight source 13 includes a blue light emitting diode chip 17, and a green light emitting material 18, such as a green fluorescent body, a green quantum dot material, any other suitable material, or any combination thereof. In the example of FIG. 6, the organic fluorescent material 15 or the green light emitting material 18 is mixed into the package layer of light emitting diode. The light-conversion element 14 includes a resin layer 16 and an organic fluorescent material 15 is mixed into the resin layer 16. The green light emitting material 18 is mixed into the resin layer 16. In the embodiment as indicated in FIG. 6, the stacking sequence of the material layer of the green light emitting material 18 and the light-conversion element 14 can be exchanged according to the characteristics of the materials or the needs of the spectrum generated by the backlight source 13, and the present disclosure is not limited thereto.

In some embodiments as indicated in FIG. 7, the backlight source 13 includes a blue light emitting diode chip 17 and a yellow light emitting material 24. The yellow light emitting material 24 can include a yellow fluorescent body, any other suitable material, or any combination thereof. In the example of FIG. 7, the yellow fluorescent body is mixed into a package layer of the light emitting diode. The light-conversion element 14 includes a resin layer 16 and an organic fluorescent material 15 is mixed into the resin layer 16. The yellow light emitting material 24 is also mixed into the resin layer 16. In the embodiment as indicated in FIG. 7, the stacking sequence of the material layer of the yellow light emitting material 24 and the light-conversion element 14 can be exchanged according to the characteristics of the materials or the needs of the spectrum generated by the backlight source 13, and the present disclosure is not limited thereto.

In some embodiments as indicated in FIG. 8, the backlight source 13 includes a blue light emitting diode chip 17 and a green light emitting diode chip 23. The light-conversion element 14 is corresponding disposed on the light emitting diode chip 23 and includes a resin layer 16, wherein an organic fluorescent material 15 is mixed into the resin layer 16. In the example of FIG. 8, the light-conversion element 14 can be disposed only on the green light emitting diode chip 23, such that the loss of blue light can be reduced; and the wavelength conversion element 14 can absorb the green light coming from the green light emitting diode chip 23 more effectively and can be excited by the absorbed green light to emit a red light; and the red light can be combined with the of blue light to make the backlight source 13 emit a white light.

In some embodiments as indicated in FIG. 9, the backlight source 13 includes a UV light emitting diode chip 25, a blue light emitting material 26, and green light emitting material 18. The green light emitting material 18 can include a green fluorescent body or a green quantum dot material, any other suitable material, or any combination thereof. The blue light emitting material 26 can include a blue fluorescent body, a blue quantum dot material, any other suitable material, or any combination thereof. In the embodiment of FIG. 9, the green light emitting material 18 or the blue light emitting material 26 can be located in a package layer of the light emitting diode. The light-conversion element 14 includes a resin layer 16, and an organic fluorescent material 15 is mixed into the resin layer 16. The blue light emitting material 26 or the green light emitting material 18 can also be mixed into the resin layer 16. The stacking sequence of the material layer of the green light emitting material 18, the material layer of the blue light emitting material 26 and the light-conversion element 14 can be exchanged according to the characteristics of the materials or the needs of the spectrum generated by the backlight source 13, and the present disclosure is not limited thereto.

In some embodiments as indicated in FIG. 10, the backlight source 13 includes a blue light emitting diode chip 17 and two green light emitting diode chips 23. As indicated in FIG. 10, the organic fluorescent material 15 is correspondingly disposed on one of the green light emitting diode chips 23; and light emitting diode chips respectively has independent wiring and can be independently turned on or turned off, such that color mixing between different colors can be reduced. The three light emitting diode chips can work with the color filter of a display panel to increase color saturation.

In some embodiments of the present disclosure, the backlight module of the display device may further include a lens 27 disposed on the backlight source 13. The lens 27 includes an organic fluorescent material 15.

In an embodiment as indicated in FIG. 11, the backlight source 13 includes a blue light emitting diode chip 17 and a green light emitting diode chip 23. The lens 27 includes an organic fluorescent material 15. The organic fluorescent material 15 can be coated on a top surface of the lens 27 or distributed in the entire lens 27, and the present disclosure is not limited thereto. Through the said arrangement, the emission spectrum of the backlight source 13 can be changed, and the emitted light can be more uniformly distributed. In an embodiment indicated in FIG. 11, like the above embodiments, the backlight source 13 may include a blue light emitting diode chip 17 and a green light emitting material (not illustrated in the present diagram).

In some other embodiments, the backlight source 13 of FIG. 11 can be replaced by the backlight source 13 containing the organic fluorescent material 15 as indicated in FIG. 5 to FIG. 10. When the light emitted by the backlight source 13 of FIG. 11 passes through the lens 27 containing the organic fluorescent material 15, the light can be converted again by the organic fluorescent material 15, such that the full width at half maximum of the green waveband of the spectrum generated by the backlight source 13 can be further reduced.

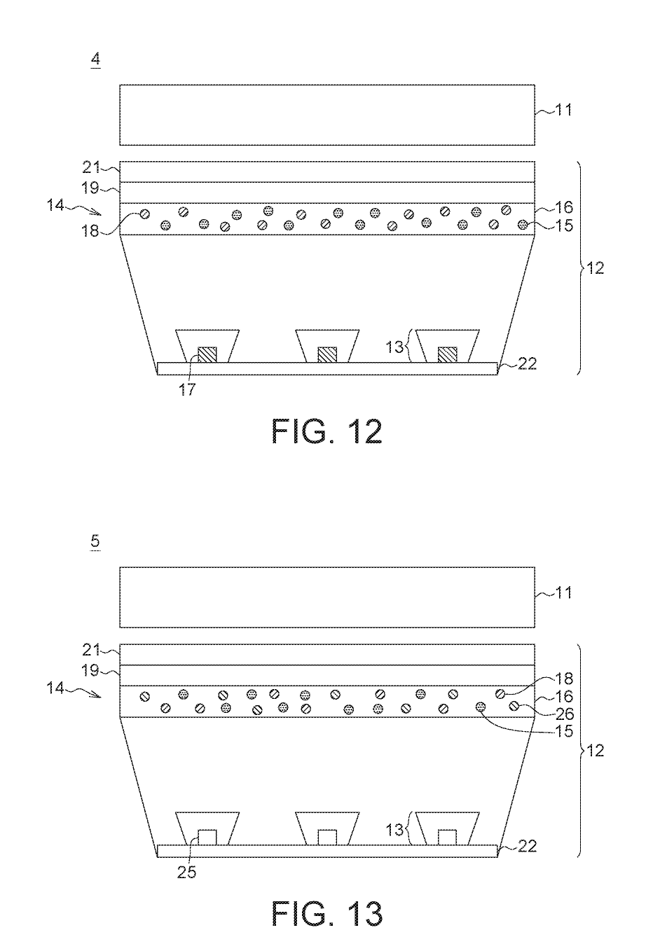

FIG. 12 to FIG. 14 are schematic diagrams of a display device according to some other embodiments of the present disclosure. For elements of the present embodiment similar or identical to that of above embodiments, similar or identical designations are used. Relevant descriptions of similar or identical elements which can be obtained with reference to above disclosure are not redundantly repeated here.

As indicated in FIG. 12, in the backlight module 12 of the display device 4, the light-conversion element 14 includes a resin layer 16 and an organic fluorescent material 15 or a green light emitting material 18 is mixed into the resin layer 16. The organic fluorescent material 15 and the green light emitting material 18 can be mixed within the resin layer 16 to form a light-conversion element 14. The light-conversion element 14 can be realized by a film structure. In some other embodiments, the organic fluorescent material 15 and the green light emitting material 18 can be respectively mixed within different layers of the resin layer 16 to form independent element materials (not illustrated). The independent elements can serve as a single film or can be mixed into other optical films. As indicated in FIG. 12, at least a backlight source 13 including a blue light emitting diode chip 17 is disposed adjacent a light-conversion element 14 (containing the organic fluorescent material 15 and the green light emitting material 18 mixed within the same resin layer 16). In an embodiment, the green light emitting material 18 can include a green quantum dot material, a green fluorescent body, any other suitable material, or any combination thereof. In some other embodiments, the display device 4 may further include an optical film (such as the prism sheet 19 and the brightness enhancement film 21, and the disclosure is not limited to this) disposed on the backlight source 13 and the light-conversion element 14. In some other embodiments, the position of the optical films and the position of the conversion element 14 can be suitably exchanged, and the present disclosure is not limited thereto.

As indicated in FIG. 13, in the backlight module 12 of the display device 5, the light-conversion element 14 includes a resin layer 16 and an organic fluorescent material 15, a blue light emitting material 26 and a green light emitting material 18 is mixed into the resin layer 16. The organic fluorescent material 15, the blue light emitting material 26 and the green light emitting material 18 can be mixed within the resin layer 16 to form a light-conversion element 14. The light-conversion element 14 can be realized by a film structure. In some other embodiments, the organic fluorescent material 15, the blue light emitting material 26 and the green light emitting material 18 can be respectively mixed within different layers of the resin layer 16 to form independent element materials (not illustrated). The independent elements can serve as a single film or can be mixed to other optical films. As indicated in FIG. 13, the backlight source 13 includes a UV light emitting diode chip 25, and the a light-conversion element 14 (containing the organic fluorescent material 15, the blue light emitting material 26 and the green light emitting material 18 mixed within the same resin layer 16) is disposed on the backlight source 13. In an embodiment, the blue light emitting material 26 and the green light emitting material 18 can respectively include blue quantum dots and green quantum dots (or a green fluorescent body). As indicated in FIG. 13, the display device 5 may further include the optical film (such as the prism sheet 19 and the brightness enhancement film 21) disposed on the backlight source 13 and the light-conversion element 14. In some other embodiments, the position of the optical films and that of the conversion element 14 can be suitably exchanged, and the present disclosure is not limited thereto.

As indicated in FIG. 14, the backlight module 12 of the display device 6 may further include a reflective structure 28 containing an organic fluorescent material 15 distributed therein.

In an embodiment as indicated in FIG. 14, the backlight source 13 includes a blue light emitting diode chip 17, a green light emitting diode chip 23, and a light-conversion element 14. The backlight module 12 includes the backlight source 13 and a reflective structure 28 (containing the organic fluorescent material 15).

In other embodiments, the reflective structure 28 containing the organic fluorescent material 15 can be disposed on a bottom surface (not illustrated) of the backlight source 13. In other embodiments, the backlight source 13 can be replaced by a light emitting diode containing the organic fluorescent material 15 as indicated in FIG. 5 to FIG. 10. Thus, the light emitted out of the backlight source 13 can be converted by the organic fluorescent material 15 once, and the light can be converted again by the organic fluorescent material 15 of the reflective structure 2 for a second time. Since the reflected light can be converted by the organic fluorescent material 15 twice, the light source may be absorbed by the organic fluorescent material 15 more, the full width at half maximum of the green waveband of the spectrum generated by the backlight module 12 can be further reduced, or the color saturation can be increased.

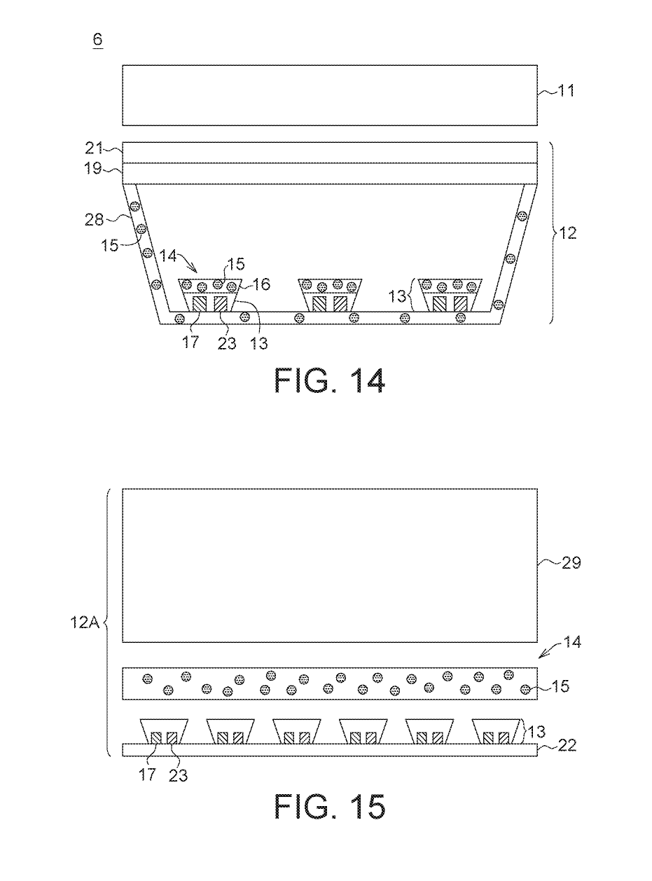

FIG. 15 is a schematic diagram of a backlight module according to an embodiment of the present disclosure. For elements of the present embodiment similar or identical to that of above embodiments, similar or identical designations are used. Relevant descriptions of similar or identical elements which can be obtained with reference to above disclosure are not repeated here.

In some embodiments as indicated in the top view of FIG. 15, the backlight module 12A includes a light guide plate 29, a backlight source 13 and a light-conversion element 14. The light-conversion element 14 can be disposed between the light guide plate 29 and the backlight source 13. In an embodiment, the backlight module 12A can be a side-type LED backlight module.

In some embodiments, as indicated in FIG. 15, the backlight source 13 includes a blue light emitting diode chip 17 and a green light emitting diode chip 23. The light-conversion element 14 can change the emission spectrum of the backlight source 13. In the embodiment as indicated in FIG. 15, like the above embodiments, the backlight source 13 includes a blue light emitting diode chip 17 and a green light emitting material (not illustrated in the present diagram).

In some other embodiments, as indicated in FIG. 15, the backlight source 13 of the backlight module 12A, depending on actual needs, can be replaced by the backlight source 13 (light emitting diode) containing the organic fluorescent material 15 as indicated in FIG. 5 to FIG. 10, and the present disclosure is not limited thereto. Since the light emitted by the backlight source 13 can be converted by the organic fluorescent material 15 twice, the light source is absorbed by the organic fluorescent material 15 more, or the full width at half maximum of the green waveband of the last generated spectrum can be further reduced.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a display panel; and
a backlight module disposed corresponding to the display panel, wherein the backlight module emits a backlight having a backlight spectrum, and the backlight spectrum comprises:
a first waveband within a range of 380 nm to 480 nm, wherein the first waveband has a first integrated light intensity I(B); and
a second waveband within a range of 481 nm to 600 nm, wherein the second waveband has a sub-waveband within a range of 550 nm to 600 nm, the sub-waveband has a integrated light intensity I(G′), and a ratio of the integrated light intensity to the first integrated light intensity (I(G′)/I(B)) is within a range of 5% to 35%.

2. The display device according to claim 1, wherein the first waveband has a crest corresponding to a first wavelength within a range of 445 nm to 455 nm, the second waveband has a crest corresponding to a second wavelength within a range of 515 nm to 545 nm, and a difference between the first wavelength and the second waveband is within a range of 66 nm to 97 nm.

3. The display device according to claim 1, wherein the first waveband has a full width at half maximum within a range of 16 nm to 22 nm, and the second waveband has a full width at half maximum within a range of 36 nm to 49 nm,

4. The display device according to claim 1, wherein the backlight spectrum further comprises a third waveband within a range of 601 nm to 780 nm.

5. The display device according to claim 4, wherein the third waveband has a crest corresponding to a third wavelength within a range of 630 nm to 660 nm.

6. The display device according to claim 5, wherein the second waveband has a crest corresponding to a second wavelength within a range of 515 nm to 545 nm, the difference between the third wavelength and the second wavelength is within a range of 102 nm to 123 nm,

7. The display device according to claim 4, wherein the third waveband has a full width at half maximum within a range of 30 nm to 60 nm.

8. The display device according to claim 1, wherein the first waveband has a crest having a first crest intensity I1, the second waveband has a crest having a second crest intensity I2, and the ratio of the second crest intensity to the first crest intensity is within a range of 25% to 70%.

9. The display device according to claim 4, wherein the first waveband has a crest having a first crest intensity I1, the third waveband has a crest having a third crest intensity I3, and the ratio of the third crest intensity to the first crest intensity is within a range of 30% to 70%.

10. The display device according to claim 4, wherein the second waveband has a crest having a second crest intensity I2, the third waveband has a crest having a third crest intensity I3, and the ratio of the third crest intensity to the second crest intensity (I3/I2) is within a range of 89% to 140%.

11. The display device according to claim 1, wherein the second waveband has a crest corresponding to a second wavelength, a second waveband central point of the second waveband corresponding to a wavelength is separated from the second wavelength by a difference, and the difference is within a range of 3 nm to 8 nm.

12. The display device according to claim 1, wherein the second waveband has a crest corresponding to a second wavelength, a second waveband central point of the second waveband corresponding to a wavelength is separated from the second wavelength, and the second wavelength is less than the second waveband central point.

13. The display device according to claim 1, wherein the second waveband has an asymmetrical shape.

14. The display device according to claim 1, wherein the second waveband has a full width at half maximum, the full width at half maximum of the second waveband is divided into a full width of the full width at half maximum with shorter wavelengths and the a full width of the full width at half maximum with longer wavelengths, and the full width of the full width at half maximum with shorter wavelengths is less than the full width of the full width at half maximum with longer wavelengths.

15. The display device according to claim 14, wherein a difference between the full width of the full width at half maximum with shorter wavelengths and the full width of the full width at half maximum with longer wavelengths is within a range of 7 nm to 8 nm.

16. A display device, characterized in that the display device comprises:
a display panel; and
a backlight module disposed corresponding to the display panel, wherein the backlight module comprises:
a backlight source; and
a light-conversion element disposed adjacent to the backlight source, wherein the light-conversion element comprises an organic fluorescent material having an absorption wavelength within a range of 550 nm to 600 nm, and the organic fluorescent material having an emission wavelength within a range of 640 nm to 650 nm;
wherein the backlight source emits a light having a first spectrum, the first spectrum is obtained before the light enters the light-conversion element, and a second spectrum is obtained after the light passing through the light-conversion element,
wherein the integrated light intensity of the second spectrum within a waveband of 550 nm to 600 nm is less than the integrated light intensity of the first spectrum within the waveband of 550 nm to 600 nm, and the integrated light intensity of the second spectrum within a waveband of 640 nm to 650 nm is greater than the integrated light intensity of the first spectrum within the waveband of 640 nm to 650 nm.

17. The display device according to claim 16, wherein the first spectrum has a fourth waveband within a range of 481 nm to 600 nm, and the fourth waveband has a full width at half maximum within a range of 50 nm to 54 nm.

18. The display device according to claim 16, wherein the second spectrum has a fifth waveband within a range of 481 nm to 600 nm, and the fifth waveband has a full width at half maximum within a range of 43 nm to 47 nm.

19. The display device according to claim 16, wherein the second spectrum has an asymmetrical shape.

20. The display device according to claim 16, wherein the light-conversion element comprises a resin layer, and the organic fluorescent material is mixed into the resin layer.
